(19) United States
(12) Patent Application Publication
(10) Pub. No.: US 2014/0019865 A1
(43) Pub. Date: Jan. 16, 2014

(54) VISUAL STORY ENGINE

(71) Applicant: Whamix Inc., San Mateo, CA (US)

(72) Inventor: Apurva Shah, San Mateo, CA (US)

(21) Appl. No.: 13/941,090

(22) Filed: Jul. 12, 2013

Related U.S. Application Data
(60) Provisional application No. 61/671,574, filed on Jul. 13, 2012.

(51) Int. Cl. G06F 3/0484

(52) U.S. Cl. CPC G06F 3/0484
USPC 715/731

(57) ABSTRACT

A system and method for creating a navigable content having a narrative structure and behaviors configured to allow a consumer to dynamically and non-linearly control many aspects of a narrative such as plot, transition, speed, story beats, media, delay, and the like, is described. The method and system also provides authoring tools to dynamically edit source material that may be adjusted and changed by a consumer during a viewing of the navigable content.

### CROSS-REFERENCE TO RELATED APPLICATIONS

This patent application claims the benefit of U.S. Provisional Patent Application No. 61/671,574, filed Jul. 13, 2012, which is incorporated by reference in its entirety for all purposes.

### BACKGROUND

Embodiments relate to media editing used to generate media content. More specifically, embodiments relate to creating stories and content narratives using media.

Using multimedia to convey stories and information is increasingly becoming popular for both authors of the content and the consumers of such media. For example, movies, comics, on-line training, on-line advertising and electronic books combine video clips, images, animation, sound, and the like to enrich the consumer's experience. Multimedia adds another dimension to the content, allowing the author to enhance the narrative in a unique way, generally far beyond the experience that is usually conveyed in print or in a movie.

Electronic devices such as tablets, computers, laptop computers, and the like are being used increasingly by consumers to play such multimedia. Generally, such electronic devices are used as output devices and have evolved to help provide the content consumer with a richer multimedia media experience than traditional newspapers, comics, books, etc.

Traditionally, stories, courses, advertising and other narratives are works of literature developed by one or more authors in order to convey real or imaginary events and characters to a content consumer. During the authoring of the story, often the author or other party such as a editor will edit the story in a manner to convey key elements of the content to the consumer. For example, the author or editor would determine the order of the narrative progression, which images to include, the timing of the various scenes, length of the media, and the like.

Narratives are generally formed in a linear fashion. For example, an author typically will construct the narrative to have a beginning, middle, and end. Narratives are typically constructed to have one storyline. Recently, authors have interwoven narratives together to make the stories and side-stories more interesting. However, such story lines are a fixed creation and have defined paths. Recently, some authors have allowed consumers to pick a path through the narrative to give the story a different storyline. This contextualized narrative can keep the consumer engaged in a story line that is more suited to the their taste and preferences.

Stories in game play serve as a backdrop or premise. However, the game play itself is not structured as narrative flow, which is what makes it fundamentally different than content narrative in the form of books, movies, comics, education, advertising, etc.

Therefore, what is needed is a method and system to provide enriched storytelling that provides the interactivity and navigability of game play within a non-linear narrative structure.

### BRIEF SUMMARY

Embodiments provide for a method for generating a navigable narrative. The method includes receiving a base narrative comprised of one or more threads. The thread in turn contains one or more display views that contain media content for display thereof to a content consumer. The display view includes multiple layers, where the layer contains the media and behavior definition to form a layer state machine. The layer state machine is responsive to state change called triggers, and to navigation within the threads. During an output of the media content and upon receiving a state change signal, the layer state machine changes the state of the media from a first media output state to a second media output state in accordance with the behavior. The output state may also contain properties that determine how the narrative proceeds forward, including non-linear jumps to associated threads.

According to an embodiment, a computer-implemented method of delivering navigable content to an output device is provided. The method is typically implemented in one or more processors on one or more devices. The method typically includes providing a base narrative comprised of one or more content threads, wherein a content thread contains one or more display views, wherein a display view contains one or more layers, and wherein at least one of the layers of a display view contains media content and a behavior definition forming a layer state machine. The method also typically includes, responsive to a state change signal, changing in the layer state machine the state of the layer from a first layer output state to a second layer output state, wherein a layer output state contains properties relating to the media display within the layer as well as navigation behavior for the narrative, and storing to a memory the content threads, layer states and layer state machines comprising the narrative structure. In certain aspects, the method also typically includes displaying on a display the display views including the media content associated with the narrative. In certain aspects, the state change signal is received from a user input device associated with the output device or a display device.

According to another embodiment, a computer-implemented method of authoring navigable content is provided. The method typically includes providing or displaying a first user interface that enables a user to create a base narrative structure comprised of one or more content threads, wherein a thread contains one or more display views, wherein a display view contains one or more layers, and wherein at least one of the layers of a display view contains media content and a layer state machine comprised of one or more behaviors. The method also typically includes providing or displaying a second user interface that enables a user to construct a layer state machine comprised of one or more behaviors, wherein the layer state machine is operable to change the state of a layer from a first layer output state to a second layer output state responsive to a state change signal, wherein a layer output state contains properties relating to the media display within the layer as well as navigation behavior for the narrative structure. In certain aspects, the narrative structure elements created by a user based on input via the first and second user interfaces are stored to a memory for later use, e.g., display and/or providing to a different system for further manipulation.

### BRIEF DESCRIPTION OF THE SEVERAL VIEWS OF THE DRAWING(S)

FIG. 1 is a high-level functional diagram illustrating one embodiment of a narrative structure.

FIG. 2 is a high-level functional diagram illustrating an embodiment of a layer finite state machine.

FIG. 3 is a high-level functional diagram illustrating one embodiment of narrative navigation.

FIG. 4A is a high-level functional diagram illustrating an embodiment of a dynamically assembled narrative jump.

FIG. 4B is a high-level functional diagram illustrating an embodiment of a dynamically assembled narrative digression.

FIG. 5 is a high-level functional diagram illustrating one embodiment of a visual story system.

FIG. 6 is an embodiment of a user interface for use with a visual story system.

FIG. 7 is an embodiment of a user interface for use with a visual story system used to create a dynamic navigable narrative.

FIG. 8 illustrates the input of media into a visual story system for processing a navigable narrative structure to play in another media display system.

FIG. 9 is a high-level flow diagram illustrating one embodiment of a method for generating a narrative using a visual story system.

FIG. 10 is a high level functional diagram illustrating one embodiment of a computer and communication system for use with the visual story system.

### DETAILED DESCRIPTION

Embodiments are directed to creating a content narrative and presentation system that allows a consumer virtually, in real time, to dynamically and non-linearly navigate the narrative and in a manner that allows the consumer to control many aspects of the narrative such as plot, transition, speed, story beats, media, delay, and the like. In one embodiment, a navigable story structure 100 is configured to provide an interactive experience with a consumer (e.g., reader, user, viewer, student, buyer, participant, etc.). For example, the consumer while viewing the story structure 100 may decide to interactively and dynamically change the type of content, the story speed, the narrative path, the media used, transitions between parts of the narrative, and the like.

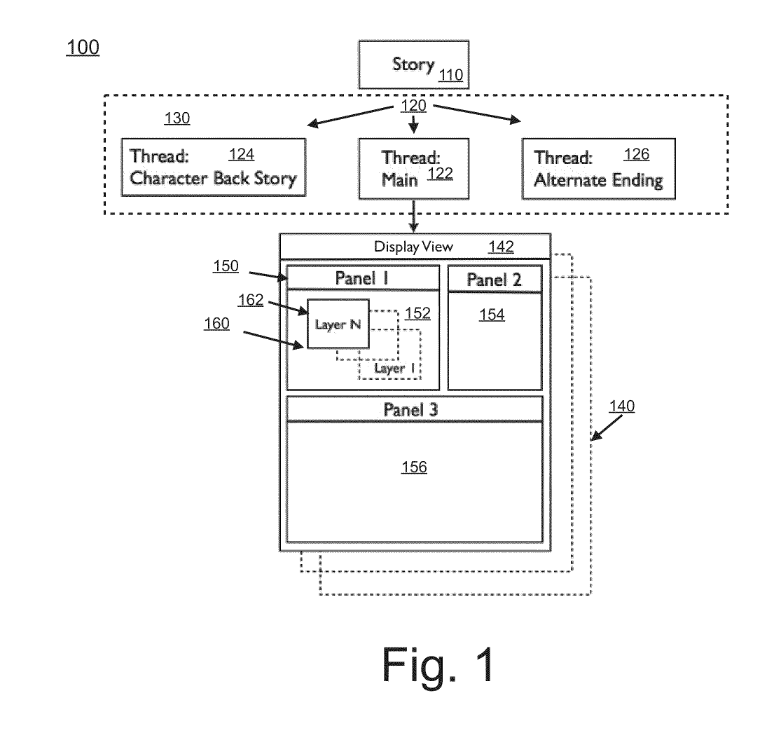

In one embodiment, the story structure 100 is a configuration of a seed or base story 110 and a collection of one or more distinct threads 120. In some embodiments, story structure 100 maintains a “stack of threads” referred to herein as a “thread stack” 130. The thread stack 130 includes some or all of the threads 120 that make up the current active story. The thread stack 130 is configured to allow the base story 110 to be dynamically and non-linearly changed by a consumer. For example, as illustrated in FIG. 1, the story structure 100 may include a base story 110, and story threads such as main thread 120, character backstory thread 130, and alternative ending thread 140.

A consumer may manipulate Story 110 in order to create a non-linear or personalized version of the story 110. For example, media components such as video, text, audio, images, and the like, may be dynamically added by pushing additional threads 120 onto the thread stack 130. Subsequently such media components can be removed or rearranged by popping them from the thread stack 130 as described herein. In some embodiments, threads 120 can be streamed from remote URLs or placed behind pay walls providing flexibility in how the content is distributed.

In an embodiment, the threads 120 are composed of one or more ordered display views 140, which are in turn each composed of one or more panels 150. The panels 150 are views that are part of at least a portion of the display views 140. Panels 150 may include one or more layers 160, ordered or unordered, that extend between the back and the front of the panels 150. The layers 160 may include any number of different media or content such as embedded behaviors, clear content, movie content, text content, image content, meta-data content, computer code, bar codes, color content, vector graphics, and the like.

Layers 160 include one or more behaviors. The states of the behavior contain visual attributes such as the size, position, color, pointers to image or movie media, etc. that determine how the layer will be rendered to screen at any given moment. The states also contain flow attributes to step back, step forward, jump within a thread, or to jump to a completely different thread of the narrative as described further herein. Additional attributes determine the nature of the branching such as if the narrative should return and restore the calling thread when the jump thread is completed as described herein.

Layers 160 may also have an editing queue associated with them. For example, when a behavior state assigns a new media pointer (URL), another preempt attribute controls if the video stream should switch immediately or if the new video should be added to the editing queue. The benefit of such an editing queue is that the video transitions can be made seamless if the two video streams connect at the transition point. “Customized Music Videos” and some of the other examples rely on the editing queue concept as described herein.

As an example, as illustrated in FIG. 1, the story structure 100 includes the base story 110 and three threads 120: a main thread 122, a back-story thread 124, and an alternate thread 126. The threads 120 are composed of display views 140, which in this illustration include a first display view 142. The first display view 142 includes three panels 150: a first panel 152, a second panel 154, and a third panel 156. The first panel 152 as illustrated includes a number, N, of layers 160. The layers 160 may include any number of content. In this example, the content may be a stream of images and corresponding audio content. When layer N 162 is selected, the content is loaded into the panel for display to the viewer via a display device such as a tablet device, mobile telephone, video display, video projector, and the like.

In addition to having bounds (position and size) and optionally something to draw, layers 160 also may act as the primary building blocks of viewer interaction. As described herein, consumers may interact with the layers 160 using virtually any input device or system. For example, for devices having a touch screen, layers 160 may respond to touch and gesture events such as single tap selection, pinch zoom and dragging. These touch events may be used to trigger a change in the state of one or more of the layers 160.

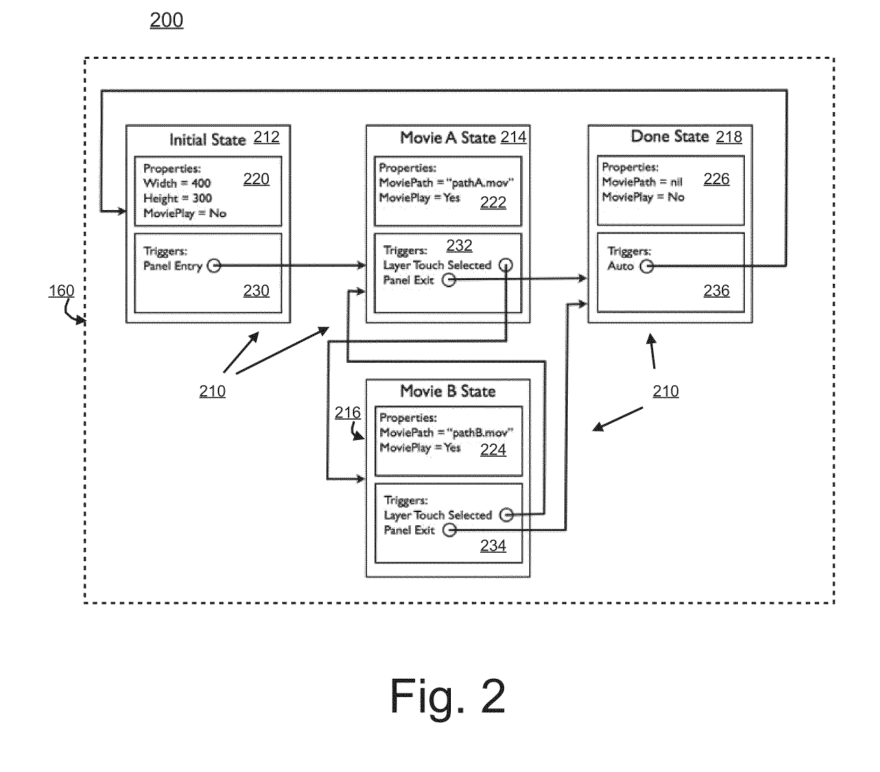

As illustrated in FIG. 2, in order to keep track of these states, a layer 160 may contain one or more Finite State Machines (FSM) to form a Layer Finite State Machine (LFSM) 200. LFSM 200 controls consumer interactions with a narrative such that the states of the behavior determine both the visual appearance and flow of the narrative. LFSM 200 includes a series of layer states 210. At least some of the layer states 210 includes two parts: a partial list of properties that govern the appearance or behavior of the layer in some way, and a list of event triggers to which the layer 160 is responsive. The triggers may be actuated by consumer action or gestures, clock or movie time, spatial relationships between layers, state transitions within other layers, etc. Triggers also have access to a global sandbox that can include personal information about the consumer and their interaction history with the current or previous narratives. This information can be used as input to conditionals that can also trigger state transitions and so influence narrative flow.

In one embodiment, in order to support multiple, overlapping behaviors LFSM 200 may be used. Unlike a FSM where generally attributes are captured in a state, the LSFM 200 provides the author with the ability to set attributes between a locked and unlocked state. Locked attributes are essentially unaffected by state transitions. The resulting behaviors are therefore more modular. In some embodiments, behaviors are “composited” to get the final overall state.

By way of illustration, FIG. 2 shows layer states 210 including an initial state 212, a movie A state 214, a movie B state 216, and a done or end state 218. Initial state 212, movie state A 214, movie state B, and done state 218, each include a property and event trigger. For example, initial state 212 includes first property 220 triggered by first event trigger 230, movie state A includes a second property 222 triggered by second event trigger 232, movie state B includes a third property 224 triggered by a third event trigger 234, and done state 218 includes a fourth property 226 triggered by a fourth event trigger 236.

Illustratively, layer 160 may be configured to transition with respect to properties for each of the states 210 in response to at least one of the first event trigger 230, second event trigger 232, third event trigger, 234, and/or fourth event trigger 236. For example, the layer 160 would change with respect to the first property 220 in response to a first event trigger 230, the layer 160 would change with respect to the movie A property 222, in response to a second event trigger 232, the layer 160 would change with respect to the movie B property 224 in response to a third event trigger 234, and/or the layer 160 would change with respect to the done property 226 in response to a fourth event trigger 236. Stated differently, in some embodiments when layer 160 transitions into a particular state such as initial state 212, movie A state 214, movie B state 216, and/or done state 218, the layer's 160 appearance and/or behavior will change based on the properties defined for those states, or combinations thereof. Further, from that point on the layer 160 will respond to event triggers associated with those states.

In some embodiments, multiple LFSMs 200 in a layer 160 may be configured to affect one or more of the properties associated with the layer 160. Further, in some embodiments a story 110 may include a global set of properties that can be accessed and modified by LFSMs 200 as well.

In an embodiment, event triggers may include at least two different types of event triggers. For example, the event trigger types may include intrinsic triggers, automatic triggers, touch based expression evaluation of layer global property triggers, panel event triggers, or triggers responsive to changes in the state of another layer's LFSM 200. In some instances, event triggers may include specific arguments to determine if the trigger's conditions are met, for example “time” may be used for duration triggers. For example, a first event trigger 230 is illustrated as a “panel entry” event trigger type that is responsive to a panel data output, such as a touch panel control signal. Triggers may also be configured to contain a target state. After an event has successfully triggered, the LFSM 200 will transition to the target state.

As illustrated in FIG. 2, LFSM 200 may be configured to allow a consumer to modify how a movie may be played in response to inputs from a consumer via, for example, an input panel device, some of which are described herein. As illustrated, in response to a consumer's input, the layer 160 responds to “panel inputs” causing the movie to toggle between movie A state 214 and movie B state 216, which may represent different scenes of a movie, or entirely different movies. When a “panel exit” is received from a viewer, the LFSM 200 is returned to its initial state.

Visual Story System Narrative Navigation

Referring back to FIG. 1 and FIG. 2, in one embodiment, a thread stack 120 may be configured to allow an author to create and/or view a dynamic non-linear story 110. For example, consider the case of a single thread linear story 110. When the consumer begins, the initial thread 122 (often called “Main”) is first pushed on the thread stack 130 causing the display view 140 to be delivered to the screen, e.g. first display view 142, first panel 152, and N layer 162. As the consumer advances, the output (e.g. read head or viewing index point) moves to the next panel, e.g., second panel 154. On reaching the last panel 152 on a display view 140, e.g., third panel 156, the output advances to the next display view 140. This continues until the last display view 140 of the last panel 150 is reached at which point the output cannot advance any further.

In another embodiment, the LFSM 200 may be used to move from the linear narrative described above to a non-linear narrative. For example, in addition to layer properties 220, 222, etc., a layer's state may also contain navigation properties that specify how the narrative will progress if that particular state is triggered. In addition to linear navigation commands such as moving forward or back in the narrative, the state may contain properties to jump to a specific location that may be another display view and panel within the same thread or an entirely different thread. For example, a LFSM trigger such as 232 may cause the narrative to digress from story thread Main (122) to Character Back Story thread 124. Additional properties may give further clues on how to achieve the narrative transition. For example, whether the associated thread, such as story thread 124, will transition back to the current thread, such as story thread 122, on completion and whether story thread 122 will be restored. If the narrative jumps to a new story thread, such as story thread 124, it is pushed onto the thread stack 130. In this way, the dynamic structure of the narrative can be expanded and modified.

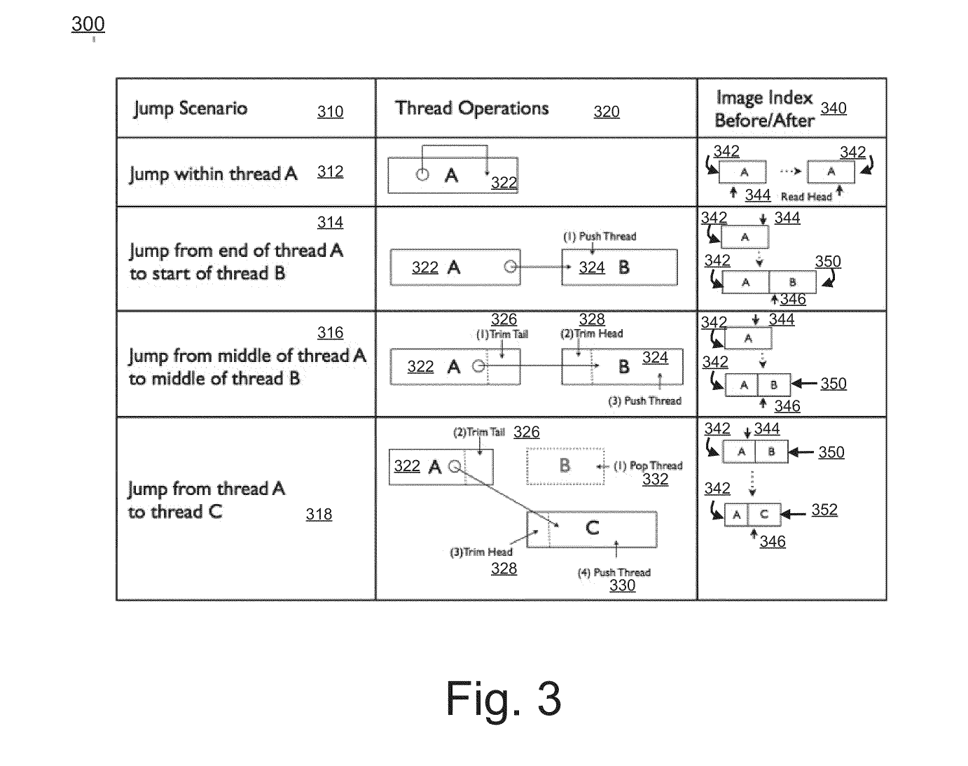

For example, FIG. 3 illustrates a sample list of jump scenarios 300 that may be associated with each layer 160 for developing or viewing a non-linear story 110. In this illustration, the scenarios included “jump” scenarios 310, thread operations 320, and affect to the image output retrieval point 340. Jump scenarios 310 use various jump properties of the thread 120 in order to jump to different panel play positions (e.g. read head positions). By way of example, panel 152 could have a text layer 160 called “Next” to explicitly move to panel 154 in the story 110.

In one embodiment, a jump property includes three parts: a thread name, a display view name or number and a panel name or number. For example, an argument may be written as: (AlternateEnding”, 1, 1), which indicates, “alternate ending, first display view 142, and first panel 152”. Once additional threads 120 are pushed on the stack 130, the point at which the media is read (i.e. the index point) may be automatically transitioned between threads 120 if possible when asked to move forward and back. For example, presuming the thread stack 130 contains two threads 130 (Main, Extra Features). The read point will advance from (Main, last display view, last panel) to (Extra Features, first display view, first panel).

By way of example, scenarios 300 illustrate variations of where the read point 342 may be moved given a jump property of a layer 160. This may be illustrated as follows: using “Jump within thread A” scenario 312, when a layer 160 is triggered, for a jump property, using the jump within thread A scenario 312, several thread operations are executed. Here, the thread A 342 has an index read point 344 positioned above a first index section of thread A 342. After the jump, the read point has moved from the first index section of thread A 342 to a second read point above a second index section of media A 342.

In this illustration, thread B 350 is pushed onto the thread stack 130 and the “jump from end of thread A to start of thread B” scenario 314 is invoked. This jump property allows the read point to move from the end of one thread 120, e.g. thread A 322, to the added thread, e.g., thread B 350. For example, using the “jump from end of thread A to start of thread B” scenario 314, the read point 344 jumps from a third index point of thread A 342, which is toward the end of the thread A play index, to a fourth play index point of thread B 350, which is near the starting index point of media B 350.

The “jump from middle of thread A to middle of thread B” scenario 316 jump property allows the read point to move from about the middle of one thread 120, e.g. thread A 322, to about the middle of an added thread, e.g., thread B 350. This jump property is configured to leave a “trim tail’ on the thread being jumped from, e.g., thread A 322, and leaves a “trim head” on the thread being jumped to, e.g. thread B 350. For example, using the “jump from middle of thread A to middle of thread B” scenario 316, the read point 344 jumps from a fifth index point of thread A 342 which is toward the middle of the thread A play index, to a sixth play index point of thread B 350, which is near the starting index point of thread B 350. The index portion of media A 342 left (not read) would be the “trim tail”. The index portion of media B 350 that is skipped would be the “trim head” portion.

The “jump from thread A to thread C” scenario 318 property allows the read point to move from an index point on one thread, e.g., thread A 342 to another pushed thread 120, e.g., thread B 344. For example, using the “jump from thread A to thread C” scenario 318, the read point 344 jumps from a seventh index point of thread A 342 which is within the index of the thread A play index, to an eighth play index point of thread C 352, which within the index of thread C 352.

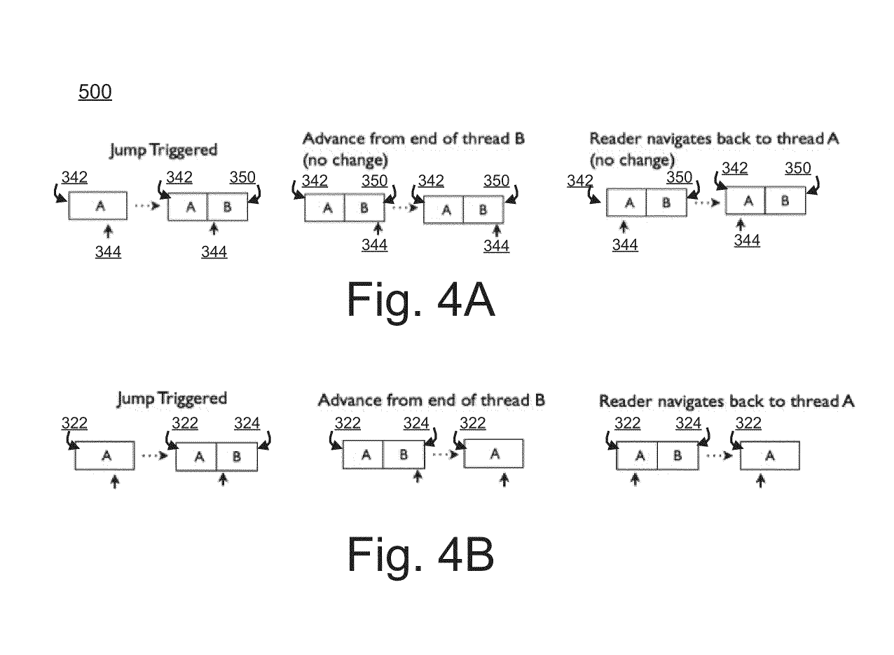

FIG. 4A and FIG. 4B illustrate other thread jump properties: restore current thread and return from target thread. These properties allow a consumer to dynamically jump or digress. For example, as illustrated in FIG. 4A, for a “do not restore current thread” scenario, if the layer 160 includes a “do not restore current thread” instruction and a “do not return from target thread” instruction, when the consumer initiates a jump from thread A 342 to thread B 350, the read point would move from a first read index point on thread A 342 to a first read index point of thread B 350. When the read point reaches the end of thread B 350, there would be no change. In other words, the read output would remain at the end of thread B. If the consumer navigates back to thread A 342, the read point would jump back to about the same location as the consumer jumped from. This mode would allow the consumer to observe another panel and then return to the narrative from about where they left off.

As illustrated in FIG. 4B, for a “return from current thread” scenario, a digression mode may be invoked by the consumer. For example, if the consumer invokes a jump from thread A 342 to thread B 350, the jump property may be set to automatically digress, or in this case set the read point to the beginning of thread B, let thread B play to the end, and then automatically jump back to the point the consumer left off at in thread A 342. The consumer may then navigate within thread A to continue the story 110. Additional properties, such as transitioning to multiple associated story threads, may provide additional information about how the thread assembly 130 is structured.

Almost infinite variations of movement within and between content may be accomplished using the above scenarios. For example, defining jumps in this way allows authors to model a wide variety of non-linear behaviors including a “table of contents page”, “choose your own adventure”, and for example, stories 110 personalized based on global properties about the consumer, footnotes, or digressions.

Visual Story System

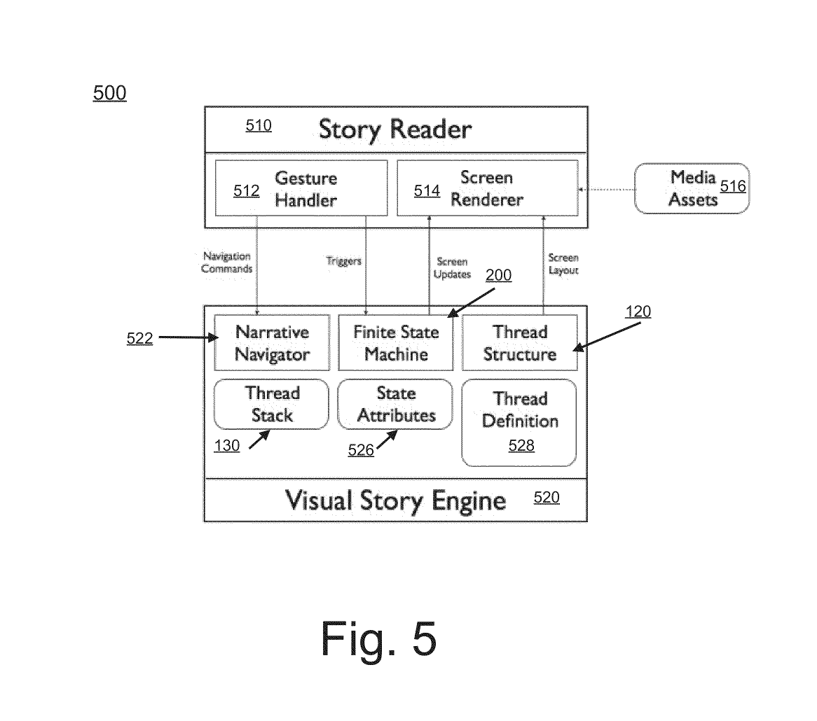

Embodiments provide a Visual Story System (VSS) 500 as shown in FIG. 5. In one embodiment, the VSS 500 includes a story reader 510 and a Visual Story Engine (VSE) 520. The story reader 510 is configured to receive input from a consumer (e.g., reader, user, viewer, student, buyer, participant, etc.), and display a story 110 to the consumer. Story reader 510 includes a display medium, e.g., display screen, as well as user interface elements, which may include the display screen itself (e.g., touch screen) and/or additional interface elements such as mouse, keyboard, pen, etc. The story reader 510 is a “user interaction” interface that allows the consumer to both view, as well as interact with the story 110 in a dynamic way. As way of an illustration, the story reader 510 may be used by someone to view content, view and modify content, modify a story thread 130, and the like. For example, a consumer can use the story reader 510 to view and interact with a movie, comic book, electronic book (e.g., ebook), multimedia presentation, and the like. The story reader 510 may also be configured to allow a consumer to directly interact with the story 110 in a dynamic way as described further herein, through interpretations of user gestures, device motions, and the like.

The story reader 510 interfaces with the VSE 520 via a gesture handler 512 and a screen renderer 514. The gesture handler 512 is configured to handle the gestures by the reader input, typically responsive to movement of the consumer's hands and fingers. In one embodiment, the gesture handler 512 may receive one or more signals representative of one or more finger gestures as known in the art such as swipes, pinch, rotate, push, pull, strokes, taps, slides, and the like, that are used as LFSM triggers such as 232, 234 within the story 110 being viewed. For example, given a dynamic story 110 configured to be changed by the consumer, a consumer may use finger gestures interpreted by the gesture handler 512 to change the story's plot, timing, story beat, outcome, and the like.

The screen renderer 514 is configured to receive media assets 516 such as audio, video, and images, controlled by the VSE 520 for display to the viewer via story reader 510. The screen renderer 514 may be used to send visual updates to the story reader 510 responsive to or based on processing done by the VSE 520. The screen renderer 514 may also be used to generate and drive the screen layout. For example, consider the case where a consumer is watching a multimedia presentation. The screen renderer 514 receives display updates and layout instructions from the VSE 520 in response to the viewer's input, and the layout instructions received from the VSE 520 with respect to the needs of the presentation. For example, as described above with regard to FIG. 1 and FIG. 2, the presentation may include panels 150 having layers 160 containing data such as still images, video segments, audio cues, screen transitions, image transition effects, and the like, that may be used by the VSE 520 in a manner to drive the screen renderer 514 to present the multimedia in a dynamic way to the consumer.

In one embodiment, the VSE 520 includes a narrative navigator 522, layer finite state machine 200, state attributes 526, thread structure 120, thread definitions 528, and the thread stack 130. The narrative navigator 522 is configured to receive and process the navigation signals from the gesture handler 512. In response to the navigation signals, the narrative navigator 522 drives changes to the narrative with regard to plot, transitions, media play, story direction, speed, and the like. For example, a consumer may configure the narrative navigator 522 to change the plot of the story from a first plot to a second plot using a swipe gesture. For example, referring to FIG. 1-3, the VSE 520 may be at an initial state 212. Upon receiving a gesture from a consumer to move the narrative from the initial state 212 to a movie A state 214, the VSE 520 in response to a trigger gesture, may move the narrative from the initial state 212 to a movie state A 214, using for example, “Jump within thread A” scenario 312 as illustrated in FIG. 3.

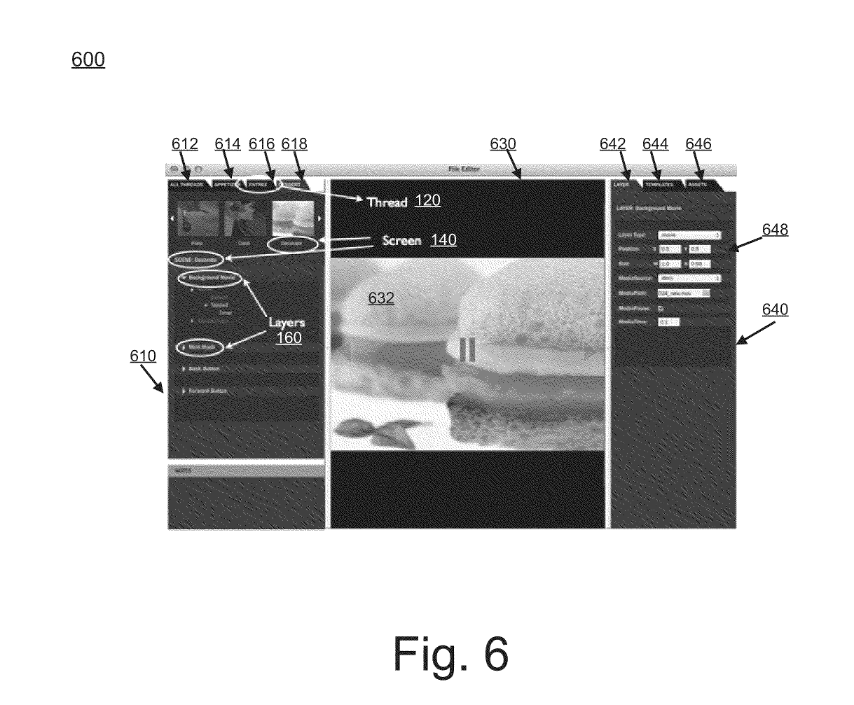

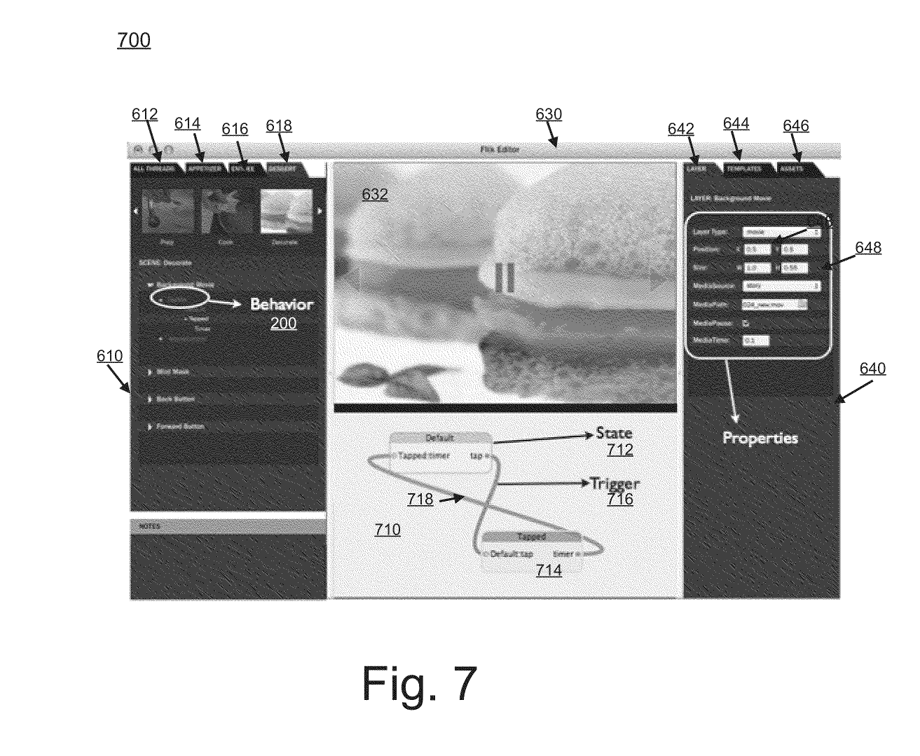

FIG. 6 and FIG. 7 illustrate a story navigation editor 600 which is a user interface (UI) used to create a story 110 for use with the VSE 520 The story navigation editor 600 includes a story outline 610. The story outline has tabs for editing atomic story threads 120 such as tabs 614, 616 and 618 or a tab 612 to view all threads and their relationships at once. Once a thread tab is selected, the author is presented with a thumbnail and hierarchical list of all display views 140 within the thread. Nested within the hierarchical list are all of the panels and layers 160 associated with the display views.

The story navigation editor 600 further includes a media output section 630 configured to display media assets 516. The media output section 630 may be configured to act as display to work in conjunction with VSE 520. For example, once the story 110 is associated with threads 120 and the thread stack 130, and the triggers and behaviors of the layers 160 are created, the media output section may be used to “play” the story 110 to the consumer for viewing and interaction therewith.

The story navigation editor 600 also includes layer editor section 640. The layer editor section 640 includes a layer tab 642 used to edit the property and content of layers, for example, layers 160. The layer tab 642 exposes properties 648 that an author may use when creating a story. The properties include specifying a layer type, position, size, path, duration of layer, and the like. In an example, the layer tab 642 may be used to position a layer within a specified position of a panel to allow the author to artistically size the layer 160, place the layer 160 within the panel 160, and set the duration of a media clip.

The layer editor section 640 also includes a template tab 644, which is used to save layer templates for use with creating dynamic stories 110. In some embodiments, templates can be created at the layer 160, panel 150, screen or thread granularity. A template may be created by removing some or all of the media pointers from the layer 160, while maintaining the structure and behaviors. In one aspect, if a layer 160 is disembodied from the rest of the story structure, it's possible to create dangling layer connections and narrative jump points. In order to “apply” the template the author may provide new or additional media pointers to resolve the dangling layer and narrative jump connections. Bootstrapping narratives with templates can be significantly faster than authoring narratives from scratch at the expense of arbitrary creative control. Since the templates contain the layers 160, media asset pointers 516, behaviors, and triggers, consumers may author narratives with their own content by binding media assets to the media assets pointers without requiring an authoring tool. The layer editor section 640 also includes an assets tab 646. The assets tab is used to associate media assets 516 with one or more layers.

Referring to FIG. 7, the story navigation editor 600 includes a thread editor 710 to set the state and trigger of the thread 120. For example, thread editor 710 has a state input/output interface 712 and an associated trigger input/output interface 714. In one embodiment, the state input/output interface 712 has a trigger connector 716 connecting one input/output point of the state input/output interface 712 to an input/output point on the trigger input/output interface 714, and another input/output connector 718 connecting another input/output point of the trigger input/output interface 714 to an input/output point of the state input/output interface 712. In this embodiment, thread editor 710 may be connected to any number of state or trigger input/output points in order to achieve the desired behavior. For example, as illustrated, upon receipt of a “tap” signal a “tapped timer” behavior will be invoked placing thread 120 into a default timer state.

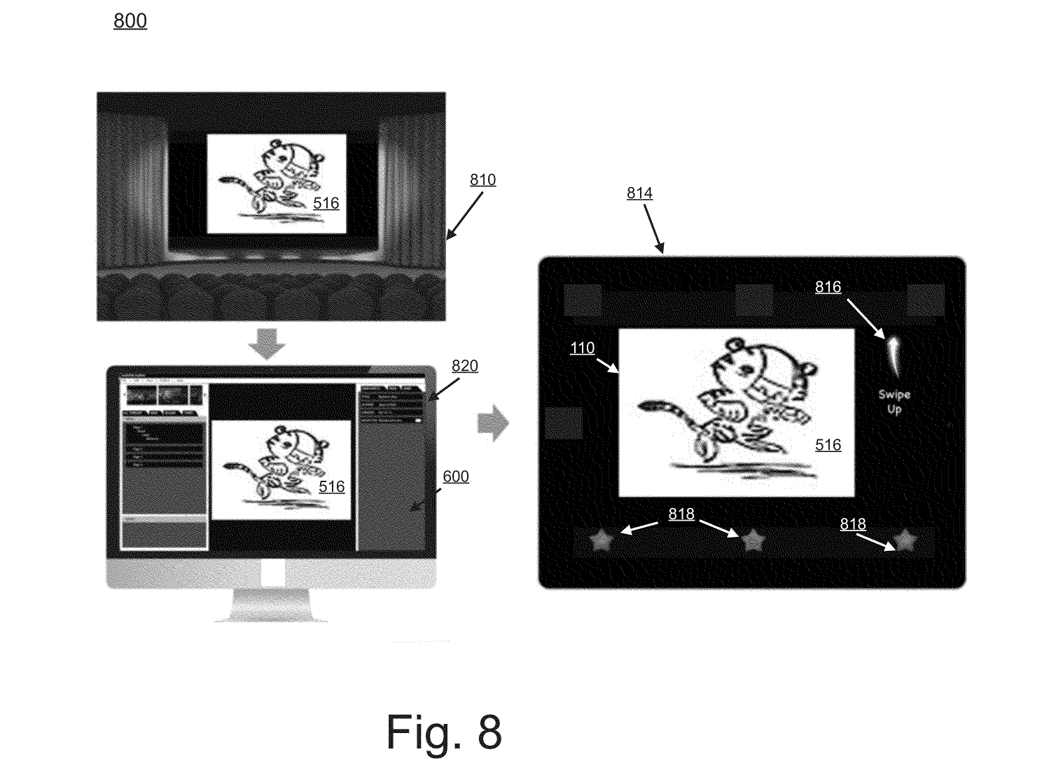

FIG. 8 illustrates an example of an input of a media asset 516 processed by story navigation editor 600. In this illustration, media asset 516 is a video asset used to play to audiences on a screen in a theater 810. An instantiation of story navigation editor 600 is displayed on a computer monitor 820. Once processed by story navigation editor 600 using the VSS 500 described herein, a navigable story 110 is resized as needed and displayed on another display device 814, such as a tablet, mobile phone, computer screen, and the like. Navigation widgets 816, 818 may be displayed based on the input trigger of the layer 160 to navigate the story 110. For example, as illustrated, “swipe” 816 and “stars” are navigation widgets in this particular instantiation of the story 110.

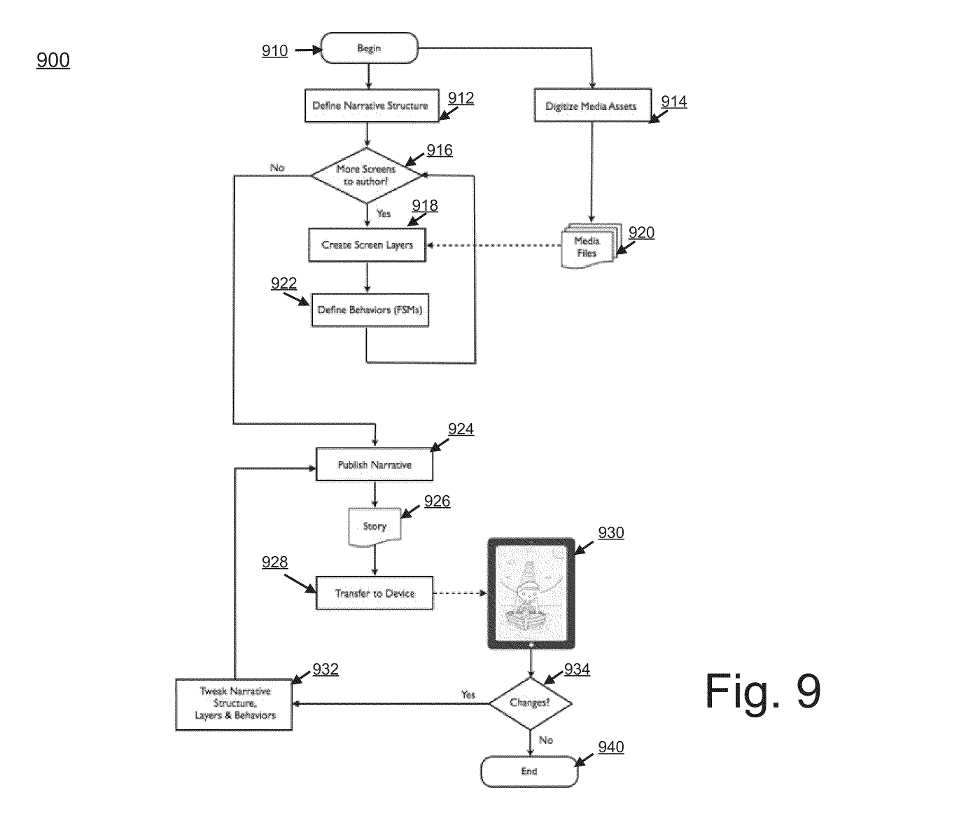

FIG. 9 is a high-level block diagram of a method 900 to create a navigable story structure 100 according to one embodiment. Method 900 starts at step 910. Method 900 moves to both 912 to define the narrative structure, and step 914 to digitize the media assets 516. At step 912 an author creates and defines a narrative structure. For example, as described herein, method 900 receives a base story 110 and story threads 120 to form a narrative structure. In step 920, media files are generated for use in the narrative structure. Once the narrative structure has been defined, in step 916 it is determined whether the author has more screens to author with respect to the narrative structure. If there are more screens to author, method 900 moves to step 918 to create the layers 160. At step 922, input is received from the author to define the behavior as described herein with respect to LFSM 200. Method 900 returns to step 916 to determine if there are more screens to process. Once all the screens have been processed, method 900 moves to publish the narrative at step 924. At step 926, the narrative structure is received and the story structure 100 is generated as described herein. In step 928, the story structure 100 is transferred to a device for display and manipulation by an author at step 930. If there are changes to make to the story structure 110, at step 934 method 900 moves to step 932 to make changes to the story structure 100, then moves back to step 924 to publish the modified narrative structure. If at step 934 there are no changes, method 900 ends at step 940.

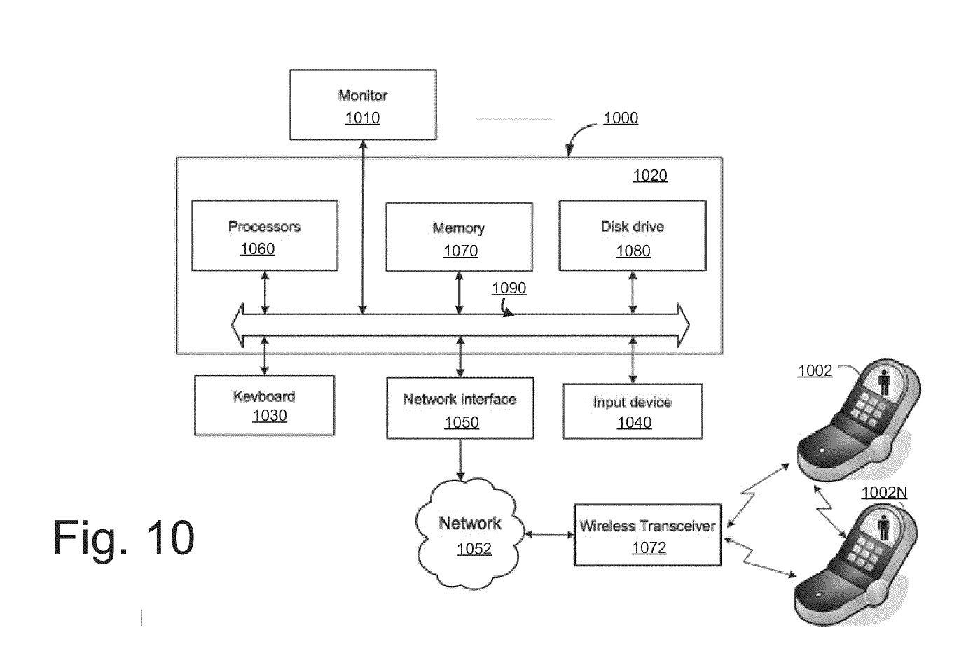

FIG. 10 is a block diagram of computer system 1000 according to an embodiment of the present invention that may be used with or to implement VSS 500. Computer system 1000 depicted in FIG. 10 is merely illustrative of an embodiment incorporating aspects of the present invention and is not intended to limit the scope of the invention as recited in the claims. One of ordinary skill in the art would recognize other variations, modifications, and alternatives.

In one embodiment, Computer system 1000 includes a display device 1010 such as a monitor, computer 1020, a keyboard 1030, a user input device 1040, a network communication interface 1050, and the like. In one embodiment, user input device 1040 is typically embodied as a computer mouse, a trackball, a track pad, wireless remote, tablet, touch screen, and the like. User input device 1040 typically allows a consumer to select and operate objects, icons, text, video-game characters, and the like that appear, for example, on the monitor 1010.

Embodiments of network interface 1050 typically include an Ethernet card, a modem (telephone, satellite, cable, ISDN), (asynchronous) digital subscriber line (DSL) unit, and the like. In other embodiments, network interface 1050 may be physically integrated on the motherboard of computer 1020, may be a software program, such as soft DSL, or the like.

In one embodiment, computer system 1000 may also include software that enables communications over communication network 1052 such as the HTTP, TCP/IP, RTP/RTSP, protocols, wireless application protocol (WAP), IEEE 802.11 protocols, and the like. In alternative embodiments of the present invention, other communications software and transfer protocols may also be used, for example IPX, UDP or the like.

Communication network 1052 may include a local area network, a wide area network, a wireless network, an Intranet, the Internet, a private network, a public network, a switched network, or any other suitable communication network. Communication network 1052 may include many interconnected computer systems and any suitable communication links such as hardwire links, optical links, satellite or other wireless communications links such as BLUETOOTH, WIFI, wave propagation links, or any other suitable mechanisms for communication of information. For example, communication network 1052 may communicate to one or more mobile wireless devices 1002 via a base station such as wireless transceiver 1072, as described herein.

Computer 1020 typically includes familiar computer components such as a processor 1060, and memory storage devices, such as a memory 1070, e.g., random access memory (RAM), disk drives 1080, and system bus 1090 interconnecting the above components. In one embodiment, computer 1020 is a PC compatible computer having multiple microprocessors. While a computer is shown, it will be readily apparent to one of ordinary skill in the art that many other hardware and software configurations are suitable for use with the present invention.

Memory 1070 and disk drive 1080 are examples of tangible media for storage of data, audio/video files, computer programs, and the like. Other types of tangible media include floppy disks, removable hard disks, optical storage media such as CD-ROMS and bar codes, semiconductor memories such as flash memories, read-only-memories (ROMS), battery-backed volatile memories, networked storage devices, and the like.

The following examples further illustrate the invention but, of course, should not be construed as in any way limiting its scope.

### Example 1

This example demonstrates using the VSS 500 to create multimedia graphic novels. This approach is termed as “reverse animatics”. Since panels 150 may have layers that are static images as well as movies and audio media, such media can be combined together in creating a multimedia experience. Viewer actions such as swipes create state transitions that navigate the viewer through the multimedia story.

### Example 2

This example demonstrates using the VSS 500 to create interactive visual books. Building on the multimedia graphic novel idea described above, layers 160 with behaviors can be embedded into individual panels 160 that cause specific visual elements to transition or be revealed; provide puzzle or gesture tasks that have to be solved to advance the narrative; and mini-games involving the story characters and environment.

### Example 3

This example demonstrates using the VSS 500 to create personalized story elements. Assuming the user has the ability to create their own images, movies or audio media via html5 or other applications (external to the VSS 500), these elements are brought in at the appropriate time in the story by simply replacing the media asset 516 of a layer 160 by the corresponding user generated asset. Any behaviors defined on that layer 160 are still active since only the media pointer attribute has been changed. This provides a very flexible way to personalize the storytelling.

### Example 4

This example demonstrates using the VSS 500 to author interactive behind the scenes data. DVDs and websites often provide a behind the scenes look at movies, music, architecture, etc. The format for these videos typically involve the artist or creator being interviewed with appropriate cut aways to visual representations of the finished product, supporting artifacts or other visual representations of what the interviewer is referring to. In one embodiment, icon layers 160 appear over the main interview video layer 160 at the appropriate time. The viewer can make a choice to “cut away” to this supporting material and stay with it as long as they like. The main interview video can either be paused during this time, continue as voice over or continue to play as a picture-in-picture layout. A viewer can even bring up multiple representations that can play along side each other and the primary video stream.

### Example 5

This example demonstrates using the VSS 500 to compare multiple time coherent visual streams. When creating visual or diagnostic media, there are often multiple representations that provide a progression towards final result. An example for animation involves the story, layout, animation and final rendered reels. An example for medicine involves physician updates, CTs, MRIs, Contrast studies, etc. Although these individual representations can be of different lengths, it is possible to put them in synch by storing a canonical timestamp within individual samples of each stream. Once this is done, VSS 500 may be configured to present all the multiple versions with the ability to interactively switch between them or even bring up multiple versions alongside each other for comparison.

### Example 6

This example demonstrates using the VSS 500 to generate customized music videos. In one embodiment, a music video consisting of multiple shots is processed by VSS 500. Some of the shots may contain close ups on the individual musicians, others may contain the band on stage, yet other may contain scenes of the crowd, etc. The VSS may process the shots to generate a presentation of these raw clips to the viewer. In some embodiments, by tapping on a specific clip or type of clips, the viewer can queue up a “live” edit list that determines how the music video will playback. Embodiments also provide the viewers with an option to insert clips of themselves into the music video sequence.

### Example 7

This example demonstrates using the VSS 500 to generate interactive video ads. Interactive ads include those ads generated by the VSS 500 where a buyer can tap on a product to get additional information about it or to even change or customize the product to match buyer's interest. One embodiment uses a behavior defined on the main product video layer 160. In response to a tap, the behavior would transition to the appropriate state (based on when and where the buyer tapped). The target state in turn would jump to an appropriate product thread that would match the buyer's interest.

### Example 8

This example demonstrates using the VSS 500 to generate personalized video ads. Similar to the example above, however, the trigger on the main product video layer's behavior could be conditionals that evaluates buyer attributes such as age, sex, geographic location, interests, etc. and jumps to the appropriate product thread 120.

### Example 9

This example demonstrates using the VSS 500 to generate social networking hooks within video streams. Tapping on a product or person presents the user with an option to tweet or post on a social network website a pre-authored, editable message accompanied by the visual image or video. Optionally, when the user is watching a video stream, they would be showed annotation anchors initiated by their friends or networks. These anchor points would be stored in an online database that would be accessed and filtered at viewing time based on the user and video clip. The result of the database query would be turned into overlay layers 160 that are displayed at the appropriate time in the video stream.

### Example 10

This example demonstrates using the VSS 500 to generate adaptable video lessons. The main video lesson is broken up into multiple video clips. These video clips are re-constituted into a linear thread 120 with multiple screens that present each video clip in sequential order. At the end of a clip a new screen is inserted that asks the student specific questions to test understanding. If understanding is verified the narrative moves forward, however, if the student fails the test, they are taken back to the previous lesson screen or even digressed to a related thread that expands the specific topic in slower and greater detail.

### Example 11

This example demonstrates using the VSS 500 to switch between multiple multi-capture visual streams. Sports and live events are often captured with multiple video streams that are in synch. In our approach the video layer 160 presenting the video stream can be switched by pressing button layers 160, which in turn cause the main video layer 160 to have a state transition that sets the video layer to the appropriate type or camera. As the layer's video transitions to a new stream, VSS 500 is able to preserve the time synch using the layer's time code attribute. In another variation, VSS 500 may use personalized information about the viewer, such as their affinity for a particular player, to preferentially switch to streams that match their interest when the alternate streams have low activity or saliency.

### Example 12

This example demonstrates using the VSS 500 to create a video blog. Bloggers can use a simple web form to provide a name for the post, meta tags and upload media assets that correspond to a fixed, pre-determined blog structure and look. This information gets populated within a story template to create the finished narrative. In one embodiment, VSS 500 allows readers to leave their comments to the post in the form of text, audio or video formats.

### Example 13

This example demonstrates using the VSS 500 to create a customizable television show. This embodiment builds on the video blogging embodiment described herein. Several lifestyle, reality and shopping shows follow a standard format. As an example, consider a classic reality television show where startup companies may pitch their company to a panel of judges. Embodiments of VSS 500 provide tools for competitors to upload information about their startup using a standardized web form. Via templates, each startup pitch gets converted to a show segment. At viewing time different pitches can be sandwiched between a standard show open and close creating a customized viewing experience. This embodiment allows viewers to watch the show at their own frequency—someone watching the show often would see the latest pitches, others watching less frequently would see the strongest pitches since their last viewing. Also, the show could be tweaked based on the viewer's personal preferences and geo location, which can be incredibly valuable for shopping shows.

### Example 14

This example demonstrates using the VSS 500 to create targeted political canvasing. Often constituents are mostly concerned with what a candidate thinks about the specific issues most relevant to them. Ideally a candidate would target their message to each individual constituent. Unfortunately this is simply not practical. In one embodiment, a message can at least be personalized. The candidate would first record their position on a large number of key issues as well as a generic opening and closing statement. When a constituent accesses the message, the VSS 500 would queue up the right set of relevant issues based on their demographic information. This would be implemented as a video layer behavior that uses the global sandbox to implement conditionals that queue up the position clips that are likely to have the most resonance with the viewer. In another variation, VSS 500 may use the same approach to create messages of varying lengths that maybe most appropriate to the viewing venue. For example, a streaming video ad would be just 30 s while someone coming to the candidate's web site would see a 5 m presentation.

### Example 15

This example demonstrates using the VSS 500 to allow an author to create a “choose your own adventure books or video”. This embodiment builds on the “Interactive Visual Books” embodiment described herein. An explicit viewer choice or the outcome of puzzles, gesture tasks or mini-games can determine branching in the narrative flow ultimately leading to completely different story outcomes. In this embodiment, the viewer is presented with a linear view and doesn't need to think about navigating in a complex non-linear space.

### Example 16

This example demonstrates using the VSS 500 to allow an author to create a virtual tour guide. At the start of a museum or facility tour, participants would be handed a tablet. The tablet would track the participant's location using Bluetooth or GPS. As they get to key locations, the VSS 500 would present the viewer with specific media that provides additional context about the location. The viewer may also use the tablet screen to get an annotated overlay to the physical space.

### Example 16

This example demonstrates using the VSS 500 to allow an author to collaborate on a story. Stories 110 are at the heart of large budget films, TV shows and game productions. Narrative scenario planning is at the heart of an even broader set of activities such as marketing and brand campaigns. Generally there is a team of storyboard artists and creative personnel collaborating on a project. At regular intervals the storyboards are shared in the form of a story reel/linear presentation for comments with an even larger group of decision makers. Over time the story may have multiple versions that could be active till a decision is made on a final version. Also, story versions are often spliced from different versions to combine the best elements. In one embodiment, the VSS 500 is configured to use the thread based, nonlinear narrative structure to store different story versions. Using behaviors and layer interaction, VSS 500 provides the mechanism to pick between different versions. The VSS 500 can also provide feedback/annotation tools that integrate note creation right within the story review. Notes maybe viewed/heard (alongside storyboard presentations) by other collaborators on the team with permission controls to modulate access.

### Example 17

This example demonstrates using the VSS 500 to allow an author to generate a social story cluster. Authors contribute real life or fictional stories. Story panels 150 are tagged or auto-tagged with specific keywords when appropriate/possible. Tagged keywords can include location, time, famous people & events, emotions, etc. Readers enter the story cluster through a specific thread 120 that is shared with them by friends or relatives. In navigating through the story 110 the reader comes to a panel with tagged keywords. Before presenting this panel, the system checks its database for panels in other story threads 120 with a matching keyword. If a match is found, the current panel is presented to the reader with an option to digress to the alternate story thread. If they decide to follow this new thread, the current thread 120 is pushed so they can return to it later. In another embodiment, VSS 500 blurs the line between readers and authors. As a reader is going through a story, they may have a related story of their own to share. The VSS 500 would allow them to switch to an authoring mode where they create their own story thread. In an embodiment, a permanent bidirectional link may be created between the original thread 120 and new threads 120.

### Example 18

This example demonstrates using the VSS 500 to allow an author to generate customized views with eye tracking. This builds on the examples of “Personalized Video Ads”, “Customizable TV Shows” and “Targeted Canvassing” described herein. In one embodiment, by incorporating eye tracking as a way to determine the viewers interest elements in the video stream. For example, in a travel video the viewer is initially presented with many different locations either simultaneously (as multiple video layers on the screen) or sequentially. Based on the eye direction, eye darts and frequency of blinks we can establish a correlation to interest in specific locations. Once this is established, the behavior can jump to a thread 120 of that location.

### Example 19

This example demonstrates using the VSS 500 to allow an author to generate social, Multi-POV variables. These are the story equivalent of massive, multi-player games. When viewers begin the story 110 they are assigned a “player” identity, which represents their point of view (POV) within the story. As the story progresses, players maybe asked to make choices that can lead to further refinement of their identity and role in the story 110. While the over all story's plot is shared by all players, the specific version of the story 110 they experience and the information they have is determined by the player's identity. For example, we could have a future world that is undergoing social unrest and revolution. Player would take on the identity of politicians, rebels, soldiers, priests, etc. in this future world. A soldier who makes choices in story navigation that reveals a sympathetic bias towards the rebels may get an identity refinement that may take them on a story path of a double agent. Certain global events—a massive explosion in the kingdom or the defection of a King's General—would be shared knowledge experienced by everyone, however, specific events and information leading up to these global events maybe known only by certain players. In a further enhancement, players may take an image of their identity or some secret document from the story world into their social network (real) world. Alternatively a player may bring a photo or a talisman from their social world into the story world where it may take on specific narrative significance.

### Example 20

This example demonstrates using the VSS 500 to allow an author to customize ecommerce and merchandising transactions. Insertion of web panels 150 within the narrative creates a seamless transition from content to point of sale. This embodiment creates a distinct use case for brands looking to tie marketing content with sales. A few examples: 1) a video blog by a well-known fashion blogger would allow the user to tap on various articles of clothing she is wearing and link directly to a webpage where the clothing item can be purchased; 2) an interactive episode of a popular cartoon could insert links to merchandising pages where stuffed toys and videos can be purchased; 3) interactive political applications may be created to profile candidates during elections and would not only allow the user to jump to web pages that dive into detail on various issues, but also include a direct link to a donation page.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the embodiments (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All method or process steps described herein can be performed in any suitable order unless otherwise indicated herein or otherwise clearly contradicted by context. The use of any and all examples, or exemplary language (e.g., “such as”) provided herein, is intended merely to better illuminate the various embodiments and does not pose a limitation on the scope of the various embodiments unless otherwise claimed. No language in the specification should be construed as indicating any non-claimed element as essential to the practice of the various embodiments.

Exemplary embodiments are described herein, including the best mode known to the inventors. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, all modifications and equivalents of the subject matter recited in the claims appended hereto are included as permitted by applicable law. Moreover, any combination of the above-described elements in all possible variations thereof is encompassed unless otherwise indicated herein or otherwise clearly contradicted by context.

I claim:

1. A computer-implemented method of delivering navigable content to an output device, the method comprising:
providing a base narrative comprised of one or more content threads, wherein a content thread contains one or more display views, wherein a display view contains one or more layers, and wherein at least one of the layers of a display view contains media content and a behavior definition forming a layer state machine;
responsive to a state change signal, changing in the layer state machine the state of the layer from a first layer output state to a second layer output state, wherein a layer output state contains properties relating to the media display within the layer as well as navigation behavior for the narrative; and
storing to a memory the content threads, layer states and layer state machines comprising the narrative structure.

2. The method of claim 1, wherein the state change signal is received from a user input device associated with the display device.

3. The method of claim 1, further including:
constructing layer behaviors by compositing multiple layer state machines, wherein a layer output state property includes a lock attribute per behavior definition to determine if they can be set within that behavior;
determining a final output state property value of the layer by compositing the resulting property values of one or more behaviors; and
storing the layer output state properties with lock attribute within layer states and a compositing order of layer state machines for constructing behaviors.

4. The method of claim 1, further including:
executing a narrative jump from a first content thread to a second content thread, including trimming a display view tail of the first content thread and a display view head of the second content thread so as to recombine non-linear navigable content into a new, linear narrative structure; and
storing the new, linear narrative structure.

5. The method of claim 1, further including:
producing a personalized and contextualized narrative responsive to state change signals generated by evaluating properties attributed to a consumer or their context while consuming the content; and
storing the resulting personalized and contextualized narrative.

6. A computer-implemented method of authoring navigable content, the method comprising;
providing a first user interface that enables a user to create a base narrative structure comprised of one or more content threads, wherein a thread contains one or more display views, wherein a display view contains one or more layers, and wherein at least one of the layers of a display view contains media content and a layer state machine comprised of one or more behaviors;
providing a second user interface that enables a user to construct a layer state machine comprised of one or more behaviors, wherein the layer state machine is operable to change the state of a layer from a first layer output state to a second layer output state responsive to a state change signal, wherein a layer output state contains properties relating to the media display within the layer as well as navigation behavior for the narrative structure.

7. The method of claim 6, further including abstracting one or more properties that reference media into un-assigned pointers; and
storing the resulting thread, display view and layer templates.

8. The method of claim 7, further including assigning literal values for media assets so as to resolve un-assigned media properties in a thread, display view or layer; and
an interface to instantiate thread, display view or layer templates by assigning media properties.
